(19) United States
(12) Patent Application Publication
(10) Pub. No.: US 2026/0295381 A1
(43) Pub. Date: Oct. 1, 2026

(54) PORTABLE GAME DEVICE AND STORAGE MEDIUM

(71) Applicant: BANDAI CO., LTD., Tokyo (JP)

(72) Inventors: Chisato OSHIKIRI, Tokyo (JP); Yuri Okamoto, Tokyo (JP); Atsushi Yashiki, Tokyo (JP); Yoshinori Hori, Kyoto (JP)

(73) Assignee: BANDAI CO., LTD., Tokyo (JP)

(21) Appl. No.: 19/575,975

(22) Filed: Mar. 24, 2026

(30) Foreign Application Priority Data
Mar. 27, 2025 (JP) 2025-053559

(51) Int. Cl. A63F 13/211; A63F 13/52; A63F 13/55; A63F 13/825

(52) U.S. Cl. CPC A63F 13/211; A63F 13/52; A63F 13/55; A63F 13/825

(57) ABSTRACT

A portable game device that executes an electronic game includes: a display screen; a rotation operation portion enabling a rotation operation; and a controller configured to control a progress of the electronic game. In the electronic game, the controller is configured to: cause the display screen to display a character and a peripheral region of the character in a virtual region in which the character is present; present movement of the character by causing the peripheral region to scroll in a predetermined direction; and present a change in a movement direction of the character by rotating the peripheral region in response to the rotation operation on the rotation operation portion.

### CROSS-REFERENCE TO RELATED APPLICATIONS

This application is based on and claims priority under 35 USC 119 from Japanese Patent Application No. 2025-053559 filed on Mar. 27, 2025, the contents of which are incorporated herein by reference.

### TECHNICAL FIELD

The present disclosure relates to a portable game device and a storage medium.

### BACKGROUND

Japanese Patent Application Laid-Open Publication No. 2018-82938 describes a game device that enables an experience of an action of collecting an object while a display image of the game device is viewed.

The game device is configured such that when a device body is rotated, a display orientation of a disposed image of the object displayed on an image display unit is rotated. Further, in the game device, an operation portion enabling a rotation operation is provided in an upper portion of the device body, and a display magnification can be changed by the rotation operation.

In the related art described above, it is possible to rotate the display image by the operation of rotating the device body, but depending on a content of the electronic game, problems with operability may arise, such as a user feeling uncomfortable, and there is room for improvement in interest of a game experience.

The present disclosure provides a highly interesting game experience.

### SUMMARY

Aspects of a toy according to a technology of the present disclosure is as follows.

A first aspect of the present disclosure relates to a portable game device that executes an electronic game includes: a display screen; a rotation operation portion enabling a rotation operation; and a controller configured to control a progress of the electronic game. In the electronic game, the controller is configured to: cause the display screen to display a character and a peripheral region of the character in a virtual region in which the character is present; present movement of the character by causing the peripheral region to scroll in a predetermined direction; and present a change in a movement direction of the character by rotating the peripheral region in response to the rotation operation on the rotation operation portion.

A second aspect of the present disclosure relates a non-transitory computer-readable storage medium storing a control program for causing a portable game device to perform a process. The portable game device executes an electronic game and includes a display screen, a rotation operation portion enabling a rotation operation, and a processor configured to control a progress of the electronic game, and the process includes: causing the display screen to display a character and a peripheral region of the character in a virtual region in which the character is present; presenting movement of the character by causing the peripheral region to scroll in a predetermined direction; and presenting a change in a movement direction of the character by rotating the peripheral region in response to the rotation operation on the rotation operation portion.

### BRIEF DESCRIPTION OF DRAWINGS

Exemplary embodiment(s) of the present invention will be described in detail based on the following figures, wherein:

FIG. 1 is a diagram showing an example of an appearance of a portable game device 100 according to the present embodiment;

FIG. 2 is a diagram showing an example of a hardware configuration of the portable game device 100;

FIG. 3 is a diagram showing an example of a virtual region map used in a mini game;

FIG. 4 is a diagram (part 1) showing an example of a screen transition in the mini game;

FIG. 5 is a diagram (part 2) showing an example of the screen transition in the mini game;

FIG. 6 is a diagram (part 3) showing an example of the screen transition in the mini game;

FIG. 7 is a diagram (part 4) showing an example of the screen transition in the mini game;

FIG. 8 is a diagram (part 5) showing an example of the screen transition in the mini game;

FIG. 9 is a diagram (part 6) showing an example of the screen transition in the mini game;

FIG. 10 is a diagram (part 7) showing an example of the screen transition in the mini game;

FIG. 11 is a diagram (part 8) showing an example of the screen transition in the mini game;

FIG. 12 is a diagram (part 9) showing an example of the screen transition in the mini game; and

FIG. 13 is a flowchart showing an example of a process of the mini game executed by a processor 101.

### DESCRIPTION OF EMBODIMENTS

### Embodiment

Hereinafter, an embodiment will be described in detail with reference to the accompanying drawings. The following embodiment does not limit the disclosure according to the claims, and all combinations of features described in the embodiment are not necessarily essential to the disclosure. Two or more features of the plurality of features described in the embodiment may be freely combined. The same or similar components are denoted by the same reference numerals, and redundant description thereof is omitted.

In the embodiment described below, an example will be described in which the present disclosure is applied to a portable game device capable of executing a game (hereinafter, referred to as a raising game) of raising (growing) a character as an example of the portable game device. For example, the present disclosure is applicable as a mini game that can be played in the raising game. However, the present disclosure is applicable to any device capable of executing an electronic game. That is, the electronic game to which the present disclosure is applied is not limited to a game of a specific genre such as a raising game.

### Appearance of Portable Game Device 100 According to Present Embodiment

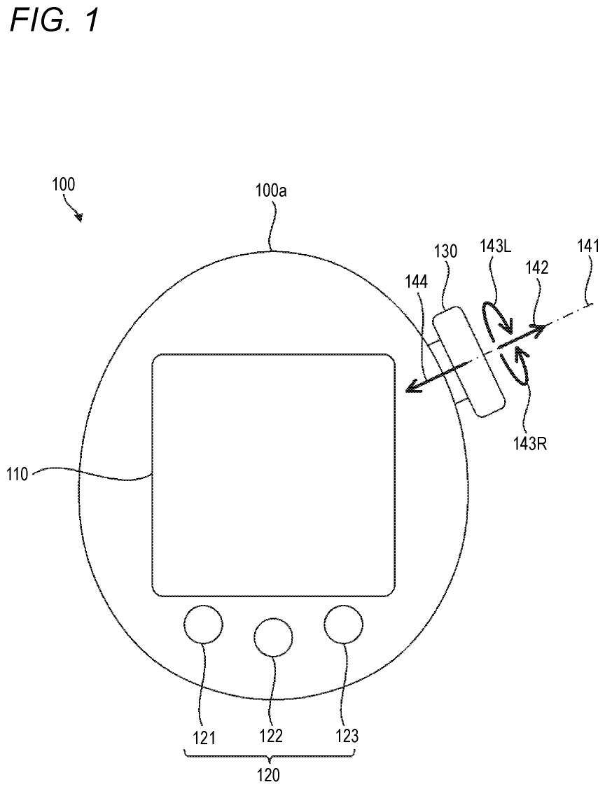

FIG. 1 is a diagram showing an example of an appearance of a portable game device 100 according to the present embodiment. In the present embodiment, the portable game device 100 is formed in a mode of a portable toy and operates using power supplied from a battery or a dry cell (not shown). In the battery-operated mode, the portable game device 100 is provided with a terminal (not shown) that can be connected to a power source, and is configured such that the battery can be charged by electrically connecting a commercial power source or the like to the terminal via a power supply cable.

In FIG. 1, the portable game device 100 is viewed from the front, and up, down, left, and right in FIG. 1 are defined as up, down, left, and right of the portable game device 100.

A body portion 100a is a housing portion of the portable game device 100, and has a circular front shape with a rounded outer peripheral surface (for example, an egg shape). The battery or the dry cell is incorporated in the body portion 100a. Further, a display 110 is provided on a front surface of the body portion 100a. The display 110 is a display screen capable of displaying various images. The display 110 is an example of a “display screen” in the present disclosure.

The body portion 100a is provided with a lower operation portion 120 and a dial 130 as operation members. The lower operation portion 120 includes buttons 121 to 123. The buttons 121 to 123 are button-type operation members that can be pressed by a user, and are provided below the display 110 on a surface on which the display 110 of the portable game device 100 is disposed. As an example, the button 121 is a selection button, the button 122 is a determination button, and the button 123 is used as a cancel button.

The dial 130 is provided in manner of protruding in a first direction 142 from a side of the body portion 100a. In this example, the first direction 142 is a direction from approximately a center of the display 110 (or approximately a center of the body portion 100a) toward upper right.

The dial 130 is a dial type (crown type) operation member enables a rotation operation performed by the user about an axis 141 along the first direction 142. The dial 130 can perform the rotation operation in a clockwise direction 143R and the rotation operation in a counterclockwise direction 143L as viewed in the first direction 142. The clockwise direction 143R is an example of a “first rotation direction” in the present disclosure. The counterclockwise direction 143L is an example of a “second rotation direction” in the present disclosure. Further, the dial 130 may be pressed in a pressing direction 144 along the axis 141. The pressing direction 144 is opposite to the first direction 142.

### Hardware Configuration of Portable Game Device

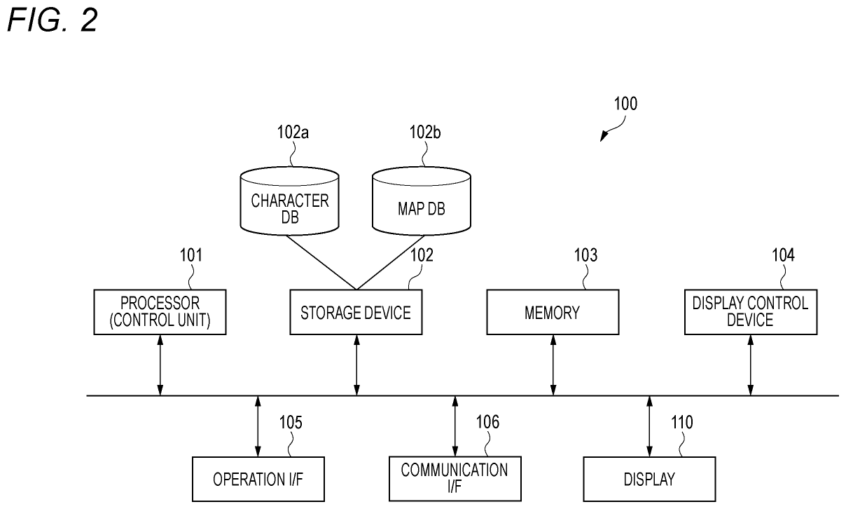

FIG. 2 is a diagram showing an example of a hardware configuration of the portable game device 100.

A processor 101 is a processor such as a central processing unit (CPU), and performs various types of control including operation control of each hardware in the portable game device 100. Specifically, for example, the processor 101 reads a necessary program stored in the storage device 102, loads the program into a memory 103, and executes the program to perform corresponding control. Further, the processor 101 includes a built-in clock and is capable of acquiring a current time. The processor 101 is an example of a “controller” in the present disclosure.

The storage device 102 is a device capable of permanently storing information, such as a nonvolatile memory. The storage device 102 stores a program related to operation of the portable game device 100, a program of the raising game (including the mini game) executed in the portable game device 100, and information of parameters necessary for achieving various types of control. In addition, the storage device 102 also functions as a database (character DB 102a) of various pieces of data related to the raising game and a database (map DB 102b) of a virtual region map used in the mini game.

The memory 103 is a storage device used for temporary data storage, such as a volatile memory. The memory 103 may be used not only as a load region for each program, but also as a storage region in which data and the like output during operations of various hardware and various types of control are temporarily stored.

The character DB 102a is a database that manages, as a record, information (character information) on a character that can be raised in the raising game. In the raising game executed in the portable game device 100 according to the present embodiment, the user can raise a character that grows through a plurality of growth stages. The character is configured such that an appearance thereof changes as the growth stage changes. The character DB 102a manages, as the record, various pieces of information on each possible appearance of the character at each growth stage.

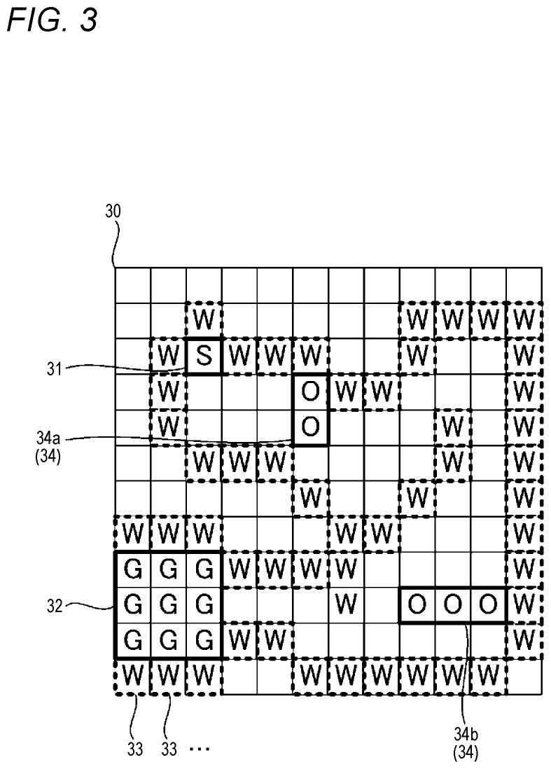

The map DB 102b is a database in which the virtual region map used in the mini game that can be played in the raising game is managed. The virtual region map will be described later (see FIG. 3, for example).

A display control device 104 performs display control of displaying various screens related to the raising game on the display 110. In the present embodiment, the display control device 104 also includes, for example, a rendering device such as a graphics chip or a graphics processing unit (GPU), and executes rendering processing of generating various screens related to the raising game. The display control device 104 includes a rendering memory (not shown), loads various pieces of graphics data read from the storage device 102, and performs a predetermined calculation to generate various images (screens) related to the raising game. The screen or image generated by the display control device 104 is presented to the user, for example, by being displayed on the display 110 provided in the portable game device 100. The display 110 is a device, such as a liquid crystal display, which is provided in the portable game device 100 and displays information. Further, the display 110 may be a touch panel capable of detecting a touch input.

A communication I/F 106 is a communication interface with an external device, which is provided in the portable game device 100. As described above, the portable game device 100 according to the present embodiment is provided with a connection terminal (not shown), and enables information communication with another portable game device 100 by connecting connection terminals to each other.

An operation I/F 105 is a user interface that receives operation input, which is provided in the portable game device 100. For example, the operation I/F 105 includes operation members such as the buttons 121 to 123 and the dial 130 illustrated in FIG. 1. When the operation input to the operation member is detected, the operation I/F 105 outputs a control signal corresponding to the operation input to the processor 101. In an aspect in which the display 110 is capable of detecting touch input, the operation I/F 105 can include a touch input detection sensor provided in the display 110.

### Detection of Rotation Operation

The operation I/F 105 detects a rotation operation amount of the dial 130. For example, the dial 130 is configured such that an input amount increases or decreases in accordance with the rotation operation amount during a period in which a rotation operation is continued after the rotation operation is first detected. Specifically, during the period in which the rotation operation is continued, the operation I/F 105 accumulates rotation operation input performed via the dial 130 as a series of operation input and sets the rotation operation input as the input amount. That is, the operation I/F 105 can accumulate a difference in a state of the dial 130 detected every moment during a period in which the dial 130 is operated and output the difference as the input amount for the series of rotation operation input. For example, the input amount is configured such that as a rotation amount of a rotation mechanism of the dial 130 increases, an absolute amount thereof increases. Hereinafter, an input amount related to operation input increased or decreased by the operation input to the dial 130 is referred to as an “accumulation amount”.

In an aspect in which the rotation mechanism of the dial 130 is rotatable, the operation I/F 105 may start to detect the accumulation amount, for example, when the rotation mechanism is rotated from a non-operation state, and intermittently output, as the accumulation amount, the rotation amount of the rotation mechanism generated in a predetermined period. In an aspect in which the rotation mechanism of the dial 130 is always biased to a fixed rotation angle (initial rotation angle) in a released state (non-operation state), the operation I/F 105 may intermittently output the rotation amount of the rotation mechanism from the initial rotation angle as the accumulation amount. In this aspect, the rotation mechanism is provided with a biasing mechanism (turning spring or the like) that biases the rotation mechanism to the initial rotation angle.

The operation I/F 105 detects the rotation operation of the dial 130 in the clockwise direction 143R and the rotation operation of the dial 130 in the counterclockwise direction 143L as different rotation operations. That is, the operation I/F 105 is capable of detecting information regarding whether the rotation operation performed on the dial 130 is in the clockwise direction 143R or the counterclockwise direction 143L, and information regarding the accumulation amount (rotation amount).

### Map Used in Mini Game

FIG. 3 is a diagram showing an example of the virtual region map used in the mini game. In the map DB 102b, for example, a virtual region map 30 shown in FIG. 3 is stored as the virtual region map used in the mini game. The virtual region map 30 is information representing a virtual region in which a character is present in the mini game. In the example of FIG. 3, the virtual region map 30 is a two-dimensional map of 12×12 squares. A size of the virtual region map is not limited to 12×12 squares, and may be set freely.

In the virtual region map 30, a start position 31, a target arrival position 32, an unenterable region 33, and an obstacle movement region 34 are set in units of squares. In FIG. 3, a square of the start position 31 is marked with “S”, squares of the target arrival position 32 are marked with “G”, squares of the unenterable region 33 are marked with “W”, and squares of the obstacle movement region 34 are marked with “O”.

The start position 31 (S) is set in only one place on the virtual region map 30 and is a region of one square. The start position 31 is a position where the character is disposed at a start of the mini game. The target arrival position 32 (G) is set in only one place on the virtual region map 30 and is a region of one or more squares. In the example of FIG. 3, the target arrival position 32 is a 3×3 region of 9 squares. The mini game is a game in which the character is moved from the start position 31 to the target arrival position 32.

A large number of unenterable regions 33 (W) are set in the virtual region map 30, and are regions into which the character cannot enter. A portion of the virtual region map 30 that is not the unenterable region 33 is a route along which the character can progress. The unenterable region 33 is set such that there is a route along which the character can progress from the start position 31 to the target arrival position 32.

The obstacle movement region 34(O) is set in one or more places and is a region in which an obstacle that obstructs movement of the character can move. In the example of FIG. 3, two obstacle movement regions 34a and 34b are set as the obstacle movement regions 34.

Each of the obstacle movement regions 34 is a region formed by a plurality of adjacent squares. In the example of FIG. 3, the obstacle movement region 34a is an obstacle movement region 34 of two squares arranged vertically, and the obstacle movement region 34b is an obstacle movement region 34 of three squares arranged horizontally. An arrangement shape of the squares in the obstacle movement region 34 is not limited to a linear shape, and may be, for example, a curved shape such as an L shape or a U shape, a rectangular shape of 2×2 squares, or a combination thereof.

In the mini game, an obstacle is disposed in each of the obstacle movement regions 34. Further, the obstacle moves in each of the obstacle movement regions 34. For example, the obstacle disposed in the obstacle movement region 34b moves in the obstacle movement region 34b. A movement method may be a reciprocating movement or a random movement.

The obstacle movement region 34 may be a region of one square. In this case, the obstacle is fixed to the obstacle movement region 34 of one square and does not move. Further, the obstacle movement region 34 may not be set in the virtual region map 30. In this case, no obstacle is disposed in the virtual region map 30.

The map DB 102b may store a plurality of virtual region maps including the virtual region map 30. The plurality of virtual region maps stored in the map DB 102b is an example of “a plurality of arrangement pattern candidates” in the present disclosure. The plurality of virtual region maps have different arrangements of objects in at least one of the start position 31, the target arrival position 32, the unenterable region 33, and the obstacle movement region 34.

For example, each time the mini game is executed, the processor 101 switches the virtual region map to be used for the mini game. For example, when three virtual region maps are stored in the map DB 102b, the processor 101 switches the virtual region map to be used such that when the mini game is executed for the first time, a first virtual region map is used, when the mini game is executed for the second time, a second virtual region map is used, when the mini game is executed for the third time, a third virtual region map is used, and when the mini game is executed for the fourth time, the first virtual region map is used. However, the virtual region map may be selected randomly at the start of the mini game, or may be selected by the user at the start of the mini game.

### Screen Transition of Mini Game

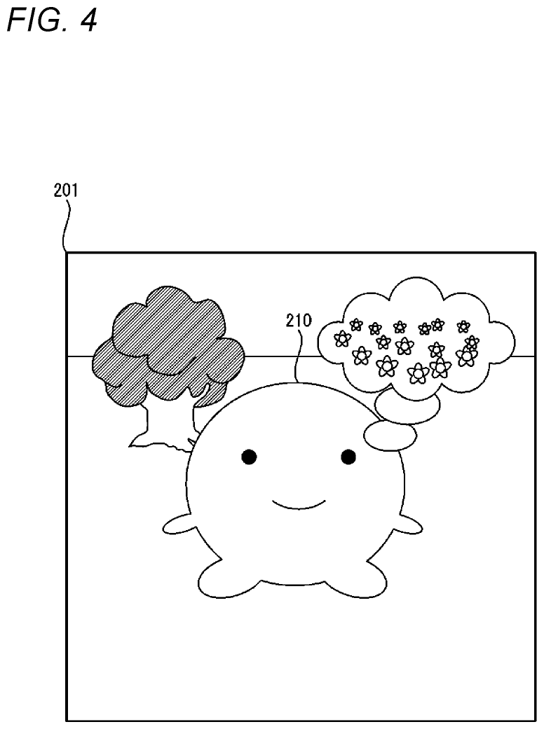

FIGS. 4 to 12 are diagrams showing examples of screen transition of the mini game. An introduction presentation image 201 and a mini game screen 202 shown in FIGS. 4 to 12 are images displayed on the display 110 (display screen) under the control of the processor 101. For example, in the raising game in the portable game device 100, the mini game is started when a specific condition is satisfied. The specific condition is, for example, that the user selects the start of the mini game from a menu screen. Further, the specific condition may include a raising stage of the character as the raising target.

At the start of the mini game, the processor 101 causes the display 110 to display, for example, the introduction presentation image 201 shown in FIG. 4. A character 210 is a character as the raising target in the raising game. In this example, the character 210 is a creature with hands and feet which walks on two legs. However, the character 210 is not limited to such a creature, and may be various creatures such as a person and an animal, may be a powered and movable robot, or may be an unpowered object such as a ball.

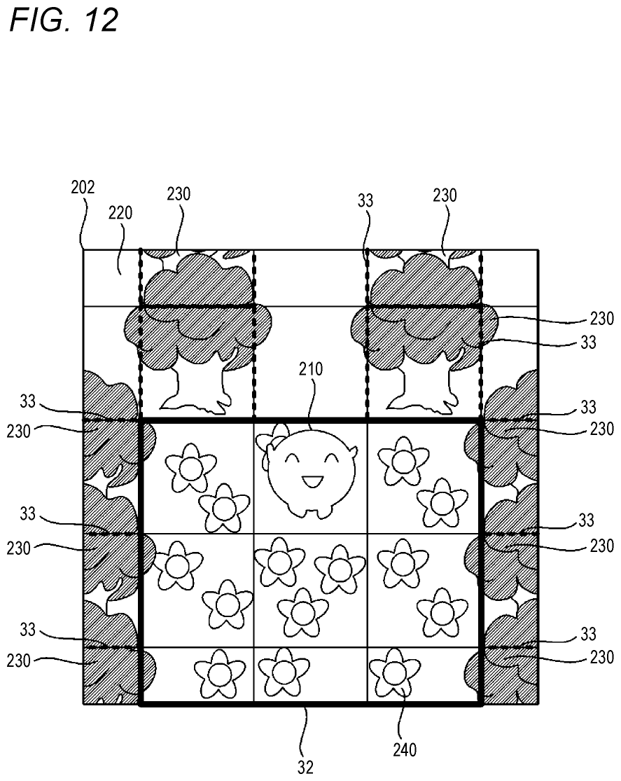

The introduction presentation image 201 is a still image or a moving image in which the character 210 imagines a situation of the target arrival position 32 is presented. In this example, the target arrival position 32 is a flower field (see FIG. 12), and the introduction presentation image 201 in which the character 210 imagines a situation of the flower field is displayed. The introduction presentation image 201 is an example of an image corresponding to a display of the target arrival position 32. By displaying such an image, the user can easily imagine a target location. Therefore, in the mini game, at a stage where the target arrival position 32 is not displayed on the display 110, the user can play the mini game while imagining the situation of the target arrival position 32 (for example, a flower field), and interest can be improved. Further, at a stage where the target arrival position 32 is displayed on the display 110, the user can easily recognize that a position is the target arrival position 32.

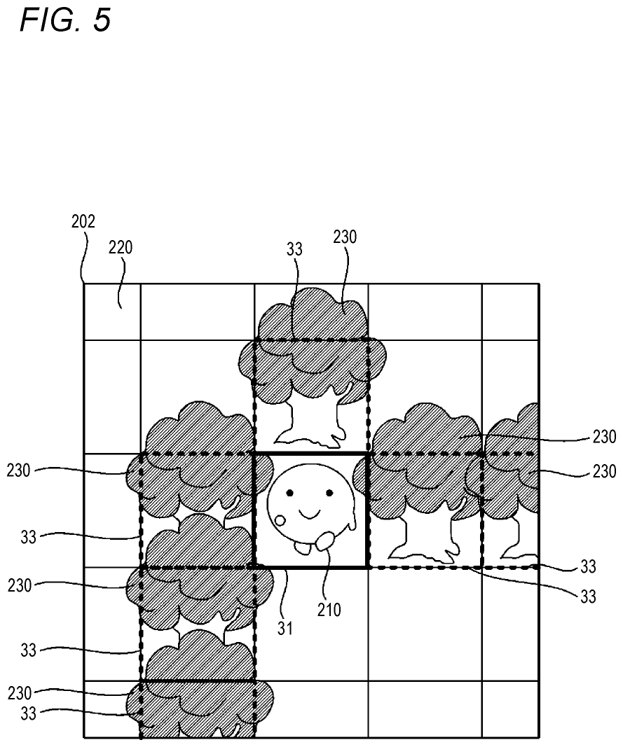

After displaying the introduction presentation image 201 for a certain time, the processor 101 causes the display 110 to display, for example, the mini game screen 202 shown in FIG. 5. The mini game screen 202 is an image displaying the character 210 and a peripheral region 220. Specifically, the mini game screen 202 is an image that displays the character 210 and the peripheral region 220 and displays the character 210 in an overlapping portion between the character 210 and the peripheral region 220.

The mini game screen 202 is an image that displays the character 210 and the peripheral region 220 from an obliquely downward perspective (top view) such that a front (face) of the character 210 is visible. At a center of the mini game screen 202, the character 210 is displayed with an image that indicates that the perspective faces downward on the screen (for presentation purposes, an image viewed such that the perspective faces forward towards the display 110). The center of the mini game screen 202 (display 110) in this case is an example of a “predetermined position” in the present disclosure.

The character 210 is displayed as an animation in which motion is performed over time (namely, in accordance with elapsing of time). For example, the character 210 is a character that walks on two legs, and an image of the character 210 putting a left leg in front and an image of the character 210 putting a right leg in front are stored in the character DB 102a. By alternately switching and displaying these images over time, the animation in which the character 210 performs the motion (motion of walking) over time is displayed.

The peripheral region 220 is an image representing only a periphery of the character 210 in the virtual region represented by the virtual region map 30 shown in FIG. 3. In this example, the peripheral region 220 is a 5×5 region within the virtual region represented by the virtual region map 30, with the square where the character 210 is currently located at the center. However, only a part (half) of each of 16 squares on the periphery of the 5×5 region is displayed. Although boundary lines of the 16 squares are illustrated for description, the boundary lines are not displayed on the display 110.

As shown in FIG. 5, in an initial state of the mini game, the peripheral region 220 is displayed such that the start position 31 (thick line frame) is disposed at a position of the character 210, that is, at the center of the mini game screen 202. Accordingly, the character 210 is located at the start position 31 in the initial state of the mini game. In the drawing, the thick line frame of the start position 31 is illustrated for description, but the thick line frame is not displayed on the display 110.

unenterable region images 230 representing the unenterable regions 33 are displayed at positions of the unenterable regions 33 (thick dotted frames) in the peripheral region 220. In this example, each of the unenterable region images 230 is an image of a tree. The tree is an example of the “first game element” in the present disclosure. The “first game element” is not limited to the tree, and may be any image that prevents entry of the character 210, such as a wall, a pillar, a pond, or a river.

In the example of FIG. 5, in the peripheral region 220 of 25 squares, 6 squares are set as the unenterable regions 33, and the unenterable region image 230 (image of the tree) are displayed in each of the unenterable regions 33 of 6 squares. Further, as in the example of FIG. 5, the unenterable region image 230 may be an image whose image size is larger than the unenterable region 33 and which extends beyond the unenterable region 33. In the drawing, a thick dotted frame of the unenterable region 33 is illustrated for description, but the thick dotted frame is not displayed on the display 110.

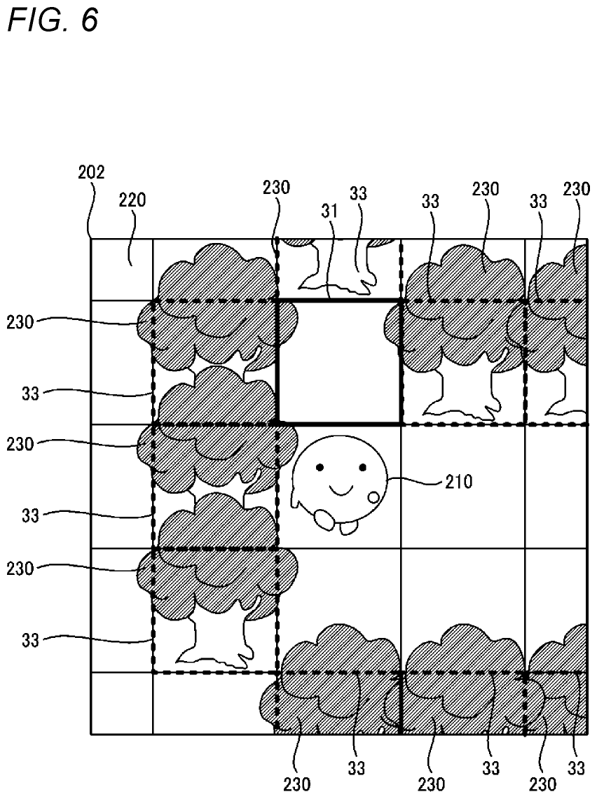

Next, as shown in FIG. 6, the processor 101 causes the peripheral region 220 to scroll upward while maintaining a display position of the character 210 in the center of mini game screen 202. The scrolling is an image process that moves, when only a part (peripheral region 220) of an entire image (image of the virtual region represented by virtual region map 30) is displayed on the display screen, a displayed range of the entire image. The upward in this case is an example of a “predetermined direction” of the present disclosure. Further, when the processor 101 causes the peripheral region 220 to scroll upward, the processor 101 also moves a display position of the unenterable region image 230 upward together with the peripheral region 220. FIG. 6 shows a state in which the peripheral region 220 scroll upward by one square from the state of FIG. 5. Accordingly, downward movement of the character 210 can be presented.

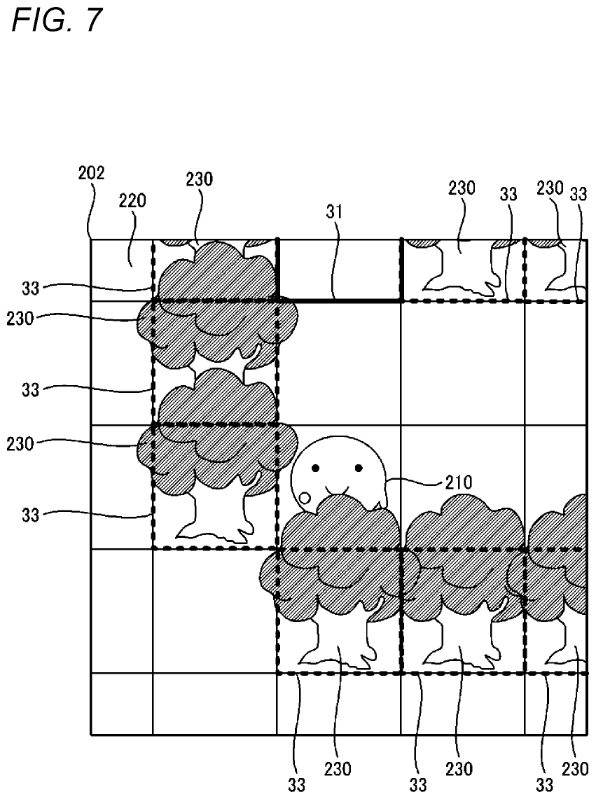

Next, as illustrated in FIG. 7, the processor 101 causes the peripheral region 220 to scroll upward. In a state of FIG. 7, the character 210 and the unenterable region image 230 (image of the tree) have an overlapping positional relationship. In this case, among the unenterable regions 33 corresponding to the unenterable region images 230 and the character 210, an image of one located at a lower portion of the display 110 is preferentially displayed. Preferentially displaying a first image out of the first image and a second image means to display the first image for an overlapping portion of the first image and the second image while displaying the first image and the second image.

In this example, the character 210 is located at the lower portion of the display 110 with respect to the target unenterable region 33. Further, as described above, since the mini game screen 202 is the image in which the character 210 and the peripheral region 220 are displayed from the obliquely downward perspective such that the front (face) of the character 210 can be seen, in this case, the target unenterable region image 230 (tree) is located in front of the character 210. Therefore, the processor 101 preferentially displays the unenterable region image 230 out of the character 210 and the unenterable region images 230. Therefore, a part of the character 210 is hidden by the unenterable region image 230 and is not displayed.

In the state of FIG. 7, since a square immediately below the character 210 is the unenterable region 33, when the peripheral region 220 further scrolls upward, the character 210 and the peripheral region 220 have an overlapping positional relationship.

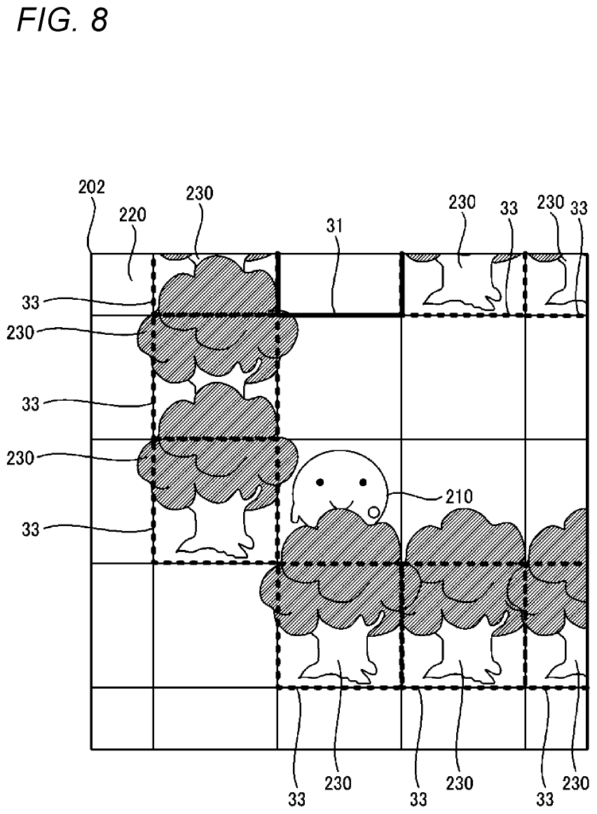

In this case, the processor 101 does not cause the peripheral region 220 to scroll as illustrated in FIG. 8. On the other hand, since the motion of walking of the character 210 is displayed as the animation, it is possible to present a state in which the character 210 cannot move because of hitting the tree and is standing still in place. In the case in which the peripheral region 220 does not scroll because the square immediately below the character 210 is the unenterable region 33, the processor 101 may display, for example, an animation that presents contact between the character 210 and an object (for example, a tree) in the unenterable region 33.

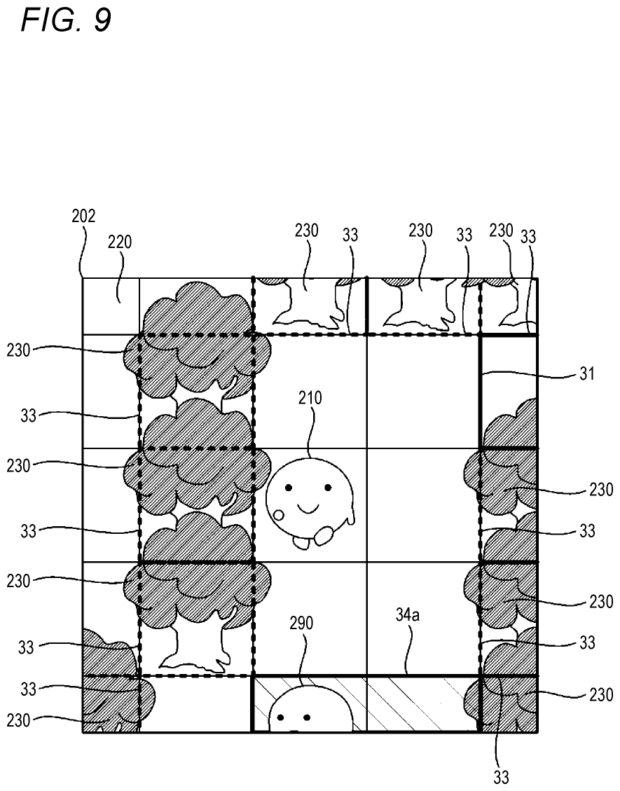

Next, it is assumed that the processor 101 receives the rotation operation of the dial 130 in the clockwise direction 143R. In this case, as shown in FIG. 9, the processor 101 rotates the display of the peripheral region 220 clockwise around the position of the character 210 (center of the display 110) while keeping the display of the character 210 facing downward on the screen. The rotation of the display of the peripheral region 220 may be a process of rotating an image itself of the peripheral region 220 or a process of moving only a display position of the object in the unenterable region image 230 and the like disposed in the peripheral region 220 in a rotation direction.

In this example, the display of the peripheral region 220 is rotated clockwise by 90 degrees. Further, the processor 101 also moves the display position of the unenterable region image 230 in a clockwise direction in accordance with the clockwise rotation of the peripheral region 220.

However, the processor 101 maintains an orientation of the unenterable region image 230 (image of the first game element). For example, the unenterable region image 230 is the image of the tree extending from bottom to top, but the unenterable region image 230 remains as an image of the tree extending from bottom to top even after the display of the peripheral region 220 is rotated. Accordingly, it is possible to avoid an unnatural presentation such as a falling tree. Further, by performing a process of changing only the display position of the unenterable region image 230, it is possible to reduce a processing amount and reduce power consumption.

Since the square immediately below the character 210 is no longer the unenterable region 33 due to the rotation of the peripheral region 220, the processor 101 causes the peripheral region 220 to scroll upward as illustrated in FIG. 9.

In the state shown in FIG. 9, the mini game screen 202 includes the obstacle movement region 34a (region surrounded by a thick line frame and shaded diagonally). An obstacle 290 is disposed in the obstacle movement region 34a. The obstacle 290 is an example of a “second game element” in the present disclosure. The obstacle 290 is an obstacle that hinders the movement of the character 210, and is moving in the obstacle movement region 34a. For example, the obstacle 290 reciprocates in the obstacle movement region 34a of 2 squares. In the drawing, the thick line frame and the oblique lines of the obstacle movement region 34 are illustrated for description, but the thick line frame and the oblique lines are not displayed on the display 110. The obstacle 290 is a ghost in this example. However, the obstacle 290 is not limited to the ghost, and may be a creature such as an animal or an insect pest, or may be an object such as a spine.

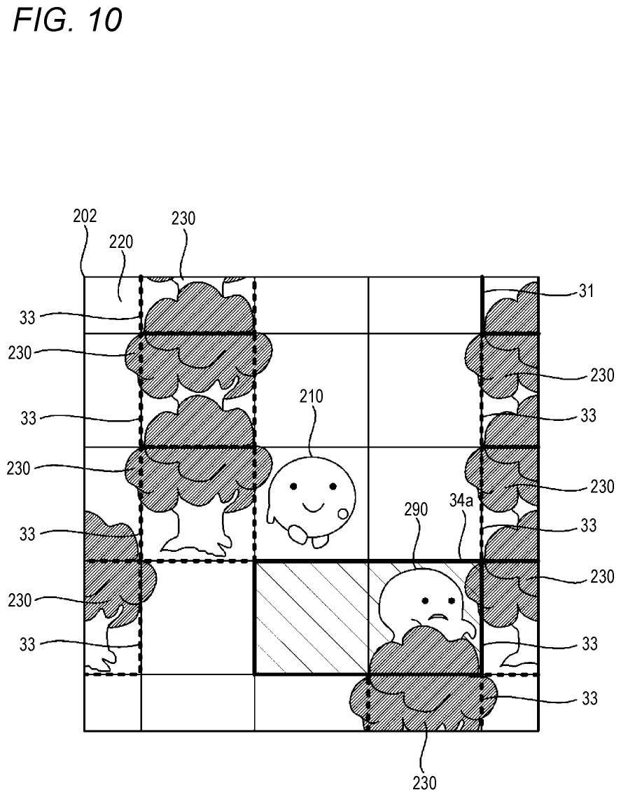

Next, as illustrated in FIG. 10, the processor 101 causes the peripheral region 220 to scroll upward. The obstacle 290 continues reciprocating in the obstacle movement region 34a.

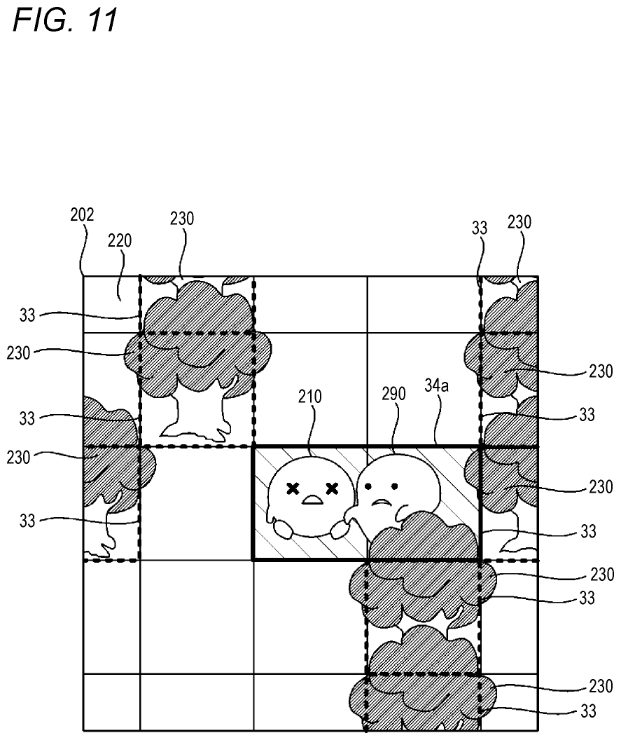

Next, as illustrated in FIG. 11, the processor 101 causes the peripheral region 220 to scroll upward. At this time, it is assumed that the character 210 and the obstacle 290 come into contact with (overlap with) each other. In this case, the processor 101 performs a presentation in which the scrolling of the peripheral region 220 is stopped for a certain time (first predetermined time), that is, the movement of the character 210 is stopped for a certain time. That is, under a condition that the scrolling of the peripheral region 220 has progressed while the obstacle 290 (second game element) remains in a positional relationship of overlapping with the character 210 during the scrolling of the peripheral region 220, the processor 101 subsequently stops the scrolling the peripheral region 220 for a certain time.

In this case, the processor 101 displays a contact image representing a state in which the character 210 and the obstacle 290 are in contact with each other for a certain time instead of the movement animation of the character 210. The contact image is, for example, an image of the character 210 that is in a stunned state (unable to act for a certain time). In an example of FIG. 11, the contact image is an image representing the character 210 being startled and falling over. The contact image may be an animation or a still image.

The processor 101 performs a presentation indicating that the movement of the character 210 is resumed by starting the scrolling of the peripheral region 220 after stopping the scrolling of the peripheral region 220 for a certain time. In this case, the processor 101 resumes displaying the movement animation of the character 210 instead of displaying the contact image of the character 210.

In a certain time (second predetermined time) immediately after the scrolling of the peripheral region 220 is stopped for a certain time, the processor 101 may set a period during which the scrolling of the peripheral region 220 (movement of the character 210) is continued even in the case in which the scrolling of the peripheral region 220 has progressed while the obstacle 290 remains in the positional relationship of overlapping with the character 210 during the scrolling of the peripheral region 220. This period is an invincible period in which the character 210 does not stop moving even if the character 210 comes into contact with the obstacle 290. By setting such an invincible period, it is possible to prevent the character 210 and the obstacle 290 from coming into contact with each other again immediately after the scrolling of the peripheral region 220 is resumed, and to improve interest.

It is assumed that the mini game progresses and the character 210 arrives at the target arrival position 32, that is, the character 210 and the target arrival position 32 overlap with each other as shown in FIG. 12. A target position image 240 representing the target arrival position 32 is displayed at a position of the target arrival position 32 (thick line frame) in the peripheral region 220. In this example, the target position image 240 is an image of the flower field. In the drawing, the thick line frame of the target arrival position 32 is illustrated for description, but the thick line frame is not displayed on the display 110.

In this case, the processor 101 causes the display 110 to display a game clear presentation image representing a state in which the character 210 has arrived at the target arrival position 32 instead of the movement animation of the character 210, and ends the mini game. The game clear presentation image is, for example, an image of the character 210 stopping movement and looking happy. Accordingly, the user can recognize that he or she has completed the mini game and can feel a sense of accomplishment.

The processor 101 may evaluate the mini game and notify the user of an evaluation result. For example, the processor 101 calculates a game score of the mini game, and displays the calculated game score on the display 110 together with the game clear presentation image. For example, the game score is calculated such that the shorter the time that has elapsed from the start of the mini game (for example, the state shown in FIG. 6) until the character 210 arrives at the target arrival position 32 (for example, the state shown in FIG. 12), the higher the game score. Further, the processor 101 may calculate the game score such that the lower the number of times the scrolling of the peripheral region 220 stops due to the contact between the character 210 and the obstacle 290, the higher the game score.

As an example, when the time that has elapsed from the start of the mini game until the character 210 arrives at the target arrival position 32 is defined as a clear time, and the number of times the scrolling of the peripheral region 220 stops due to the contact between the character 210 and the obstacle 290 is defined as the number of times of stunning, the processor 101 calculates the game score by the following formula (1). A and B are coefficients larger than 1 that are appropriately set.

$$Game score = A \times clear time - B \times the number of times of stunning \qquad ( 1 )$$

The evaluation of the mini game is not limited to the calculation of the game score of the mini game, and may be a determination of a success or failure of the mini game. For example, in the mini game, a success condition such as the clear time or the number of times of stunning is set, and the processor 101 determines whether the mini game is a success or failure based on whether the clear time or the number of times of stunning satisfies the success condition.

The processor 101 may change the game clear presentation image to be displayed when the character 210 arrives at the target arrival position 32 based on the evaluation result of the mini game. For example, the processor 101 causes the display 110 to display the game clear presentation image in which the character 210 is more pleased as the game score increases or as the success condition becomes more stringent.

The processor 101 may give a reward in the raising game to the user based on the evaluation result of the mini game. The reward in the raising game can be appropriately set, for example, in the form of growth of the character as a raising target, addition of decorative items to the character as the raising target, or changes in a raising environment.

### <Rotation of Peripheral Region 220 in Response to Rotation Operation of Dial 130>

For example, in a case in which the rotation operation in the clockwise direction 143R on the dial 130 is received, the processor 101 rotates the display of the peripheral region 220 in the clockwise direction by a rotation amount corresponding to a rotation amount of the received rotation operation in the clockwise direction 143R. Further, in a case in which the rotation operation in the counterclockwise direction 143L on the dial 130 is received, the processor 101 rotates the display of the peripheral region 220 in the counterclockwise direction by a rotation amount corresponding to a rotation amount of the received rotation operation in the counterclockwise direction 143L.

A relationship between the rotation amount of the rotation operation on the dial 130 and the rotation amount of the peripheral region 220 will be described. For example, the processor 101 rotates the peripheral region 220 by a predetermined second unit amount each time the dial 130 is rotation by a predetermined first unit amount in the same direction. As an example, the first unit amount may be 15 degrees, and the second unit amount may be 15 degrees. In this case, for example, when the dial 130 is rotated 15 degrees in the clockwise direction 143R, the peripheral region 220 is also rotated 15 degrees in the clockwise direction. Further, when the dial 130 is rotated by 90 degrees in the clockwise direction 143R, the peripheral region 220 is also rotated by 90 degrees in the clockwise direction (similar to the change from FIG. 8 to FIG. 9).

The first unit amount and the second unit amount are not limited to 15 degrees and can be freely set. For example, when the first unit amount and the second unit amount are set to 10 degrees, it becomes possible to change a movement direction more precisely. Further, the first unit amount and the second unit amount may be different amounts. For example, by setting the second unit amount to be larger than the first unit amount, such as setting the first unit amount to 15 degrees and setting the second unit amount to 30 degrees, the movement direction of the character 210 can be changed by a small rotation amount with respect to the dial 130. The second unit amount may be smaller than the first unit amount, for example, the first unit amount may be 30 degrees and the second unit amount may be 15 degrees. Further, the dial 130 may be configured to produce a mechanical click feeling each time the dial 130 is rotated by the first unit amount.

Since the virtual region map 30 is a matrix-like map with squares arranged in vertical and horizontal directions, when the peripheral region 220 scrolls upward while the peripheral region 220 is rotated less than 90 degrees and displayed diagonally, the character 210 moves diagonally relative to the vertical and horizontal directions of the virtual region map 30. In this case, the processor 101 can determine whether to cause the peripheral region 220 to scroll upward by, for example, determining whether the character 210 and the peripheral region 220 are in the overlapping positional relationship after the peripheral region 220 scrolls upward. Alternatively, the processor 101 may determine whether to cause the peripheral region 220 to scroll upward by determining whether the character 210 passes through the peripheral region 220 when the peripheral region 220 scrolls upward.

### <Background Image of Virtual Region>

For example, only one background image displayed on the display 110 as the peripheral region 220 is stored in the storage device 102. In this case, the processor 101 causes the display 110 to display the peripheral region 220 by reading the background image from the storage device 102.

Alternatively, a plurality of background image candidates may be stored in the storage device 102. In this case, the processor 101 selects the background image from the plurality of background image candidates and reads the selected background image, thereby causing the display 110 to display the peripheral region 220. The plurality of background image candidates may be, for example, an image of land (grassland), an image of water (underwater), an image of sky (above the clouds), or the like.

For example, the processor 101 may select the background image from the plurality of background image candidates depending on a state of the character 210 at the start of the mini game. The state of the character 210 may be, for example, a raising location or the raising stage of the character 210. For example, in the raising game, when the character 210 can be raised in a plurality of different raising locations, the processor 101 selects, from the plurality of background image candidates, a background image which corresponds to the raising location of the character 210 at the start of the mini game.

In the raising game, when there is a parameter representing a weather in the raising location of the character 210, the plurality of background image candidates may include an image for each weather. The plurality of background image candidates may also be background images for each combination of the raising location and the weather. The processor 101 selects, from the plurality of background image candidates, a background image which corresponds to the raising location and the weather of the character 210 at the start of the mini game.

In addition, the processor 101 may select the background image from the plurality of background image candidates in response to a selection operation received from the user, or may randomly select the background image from the plurality of background image candidates. Further, the processor 101 may also select the background image from the plurality of background image candidates so that a different background image is displayed each time the mini game is played.

When there are a plurality of background image candidates, at least one of the unenterable region image 230, an image of the obstacle 290, and the target position image 240 may be stored in the storage device 102 for each background image candidate. The processor 101 displays the unenterable region image 230, the image of the obstacle 290, and the target arrival position 32 corresponding to the selected background image on the mini game screen 202. For example, when the target position image 240 is stored for each background image candidate, an object that the character 210 imagines in the introduction presentation image 201 shown in FIG. 4 also changes depending on the selected background image.

### Process of Mini Game Performed by Processor 101

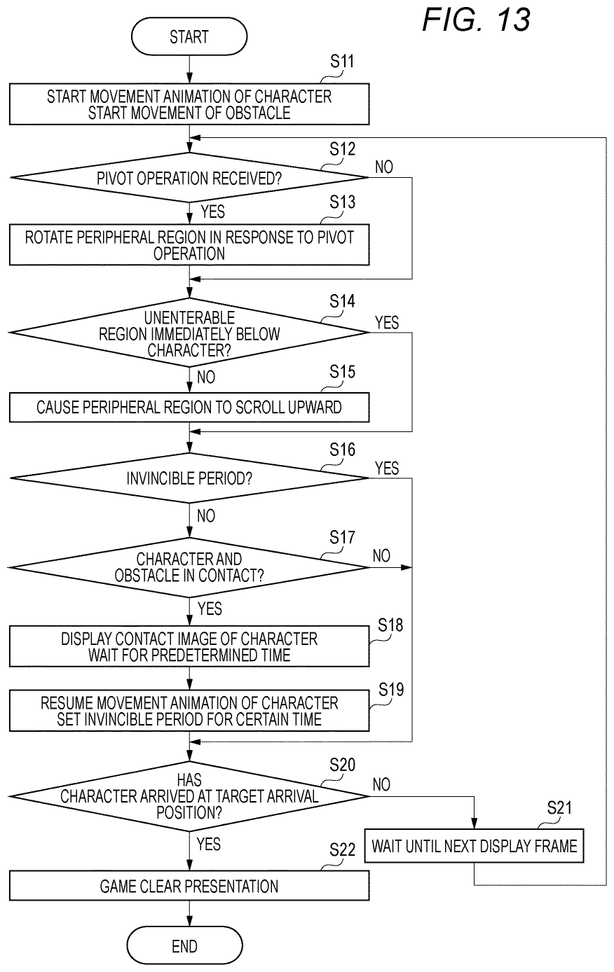

FIG. 13 is a flowchart showing an example of a process of the mini game executed by the processor 101. For example, after the introduction presentation image 201 shown in FIG. 4 is displayed on the display 110 for a certain time, the processor 101 starts the process shown in FIG. 13 in a state in which the mini game screen 202 shown in FIG. 5 is displayed on the display 110, that is, in a state in which the character 210 is disposed at the start position 31.

First, the processor 101 starts the display of the movement animation of the character 210 and starts movement of the obstacle 290 (step S11). Accordingly, the display of the movement animation (for example, the animation of the motion of walking) of the character 210 is started at the center of the screen. Further, the obstacle 290 starts to move in each of the obstacle movement regions 34.

Next, the processor 101 determines whether the rotation operation on the dial 130 is received (step S12). When the rotation operation on the dial 130 is not received (step S12: No), the processor 101 proceeds to step S14.

In step S12, when the rotation operation on the dial 130 is received (step S12: Yes), the processor 101 rotates the display of the peripheral region 220 in response to the received rotation operation (step S13). Further, the processor 101 also moves display positions of the unenterable region image 230, the target position image 240, and the obstacle 290 in the rotation direction in accordance with the rotation of the display of the peripheral region 220.

Next, the processor 101 determines whether a region immediately below the character 210 is the unenterable region 33 (step S14). When the region immediately below the character 210 is the unenterable region 33 (step S14: Yes), the processor 101 proceeds to step S16.

In step S14, when the region immediately below the character 210 is not the unenterable region 33 (step S14: No), the processor 101 causes the peripheral region 220 to scroll upward (step S15). At this time, the processor 101 also moves the display position of the unenterable region image 230 upward in accordance with the upward scroll of the peripheral region 220.

Next, the processor 101 determines whether a current time is the invincible period described later (step S16). When the current time is the invincible period (step S16: Yes), the processor 101 proceeds to step S20.

In step S16, when the current time is not the invincible period (step S16: No), the processor 101 determines whether the character 210 and the obstacle 290 are in contact with each other (step S17). When the character 210 and the obstacle 290 are not in contact with each other (step S17: No), the processor 101 proceeds to step S20.

In step S17, when the character 210 and the obstacle 290 is in contact with each other (step S17: Yes), the processor 101 causes the display 110 to display the contact image of the character 210 instead of displaying the movement animation of the character 210, and waits for a predetermined time (step S18).

Next, the processor 101 resumes the display of the movement animation of the character 210 instead of the display of the contact image of the character 210, and sets the invincible period for a certain time from this time point (step S19). In the invincible period, the processor 101 may set the movement animation of the character 210 to a movement animation that allows the user to recognize that the period is the invincible period (as an example, an animation in which the character 210 moves while blinking) instead of the normal movement animation.

Next, processor 101 determines whether the character 210 has arrived at the target arrival position 32 (step S20). When the character 210 has not arrived at the target arrival position 32 (step S20: No), the processor 101 waits until a next display frame (step S21), and returns to step S12. The display frame is a frame at a periodic interval for updating the mini game screen 202, and is, for example, a frame at intervals of tens to hundreds of milliseconds. Accordingly, processing of steps S12 to S19 is executed for each display frame, and the movement of character 210 is presented as the peripheral region 220 scrolls.

In step S20, when the character 210 has arrived at the target arrival position 32 (step S20: Yes), the processor 101 performs game clear presentation (step S22), and ends a series of processing of the mini game.

As described above, the portable game device 100 includes the display 110 (display screen), the dial 130 (rotation operation portion) that enables the rotation operation, and the processor 101. In the mini game (electronic game), the processor 101 causes the display 110 to display the character 210 and the peripheral region 220 of the character 210 in the virtual region in which the character 210 is present, causes the peripheral region 220 to scroll upward (in the predetermined direction) to present downward movement of the character 210, and rotates the peripheral region 220 in response to the rotation operation on the dial 130 to present a change in the movement direction of the character 210. The movement of the character 210 due to the scrolling of the peripheral region 220 is performed automatically, for example, over time.

Accordingly, for example, the user can move the character 210 in a two-dimensional direction including the change in the movement direction only by performing the rotation operation on the dial 130. Further, the user can change the movement direction of the character 210 by a rotation direction of the rotation operation. Therefore, the user can move the character 210 including the change in the movement direction by a simple and intuitive operation. Therefore, it is possible to provide a highly interesting game experience.

By presenting the movement of the character 210 by causing the peripheral region 220 to scroll, it is possible to present the movement of the character 210 in an easy-to-understand manner while displaying the character 210 in a larger size, compared to a configuration in which the movement of the character 210 is presented by, for example, changing the display position of the character 210. Therefore, even in the case of small display 110, the movement of character 210 can be presented in an easy-to-understand manner, and the portable game device 100 can be miniaturized. Further, by maintaining and displaying the character 210 at the predetermined position without moving the character 210 on the display screen, a burden of information processing required for displaying the game screen can be reduced.

Since only the dial 130 is required as the operation member that moves the character 210 in two dimensions, the number of parts can be reduced compared to a configuration that includes, for example, four buttons for instructing the movement up, down, left, and right.

As described above, according to the portable game device of the present embodiment, it is possible to provide a more interesting game experience.

A control method described in the above-described embodiment (for example, a control method according to the process illustrated in FIG. 13) can be achieved by executing a control program prepared in advance by a computer. The control program is recorded in a computer-readable storage medium and executed by being read from the storage medium. The control program may be provided in a form stored in a non-transitory storage medium such as a flash memory, or may be provided via a network such as the Internet. The computer that executes the control program may be included in the portable game device, may be included in an electronic device such as a smartphone, a tablet terminal, or a personal computer capable of communicating with the portable game device, or may be included in a server device capable of communicating with the portable game device and the electronic device.

### Modifications

Although the configuration has been described in which the movement of the character 210 by causing the peripheral region 220 to scroll is performed automatically over time, the movement of the character 210 by causing the peripheral region 220 to scroll may also be performed by a user operation, for example. For example, the movement of the character 210 by causing the peripheral region 220 to scroll may be performed only while a specific button (for example, the button 121 or the dial 130) is pressed by a user.

Aforementioned embodiments are summarized as follows.

A portable game device executes an electronic game. The portable game device includes: a display screen; a rotation operation portion enabling a rotation operation; and a controller configured to control a progress of the electronic game. In the electronic game, the controller is configured to: cause the display screen to display a character and a peripheral region of the character in a virtual region in which the character is present; present movement of the character by causing the peripheral region to scroll in a predetermined direction; and present a change in a movement direction of the character by rotating the peripheral region in response to the rotation operation on the rotation operation portion.

The controller may be configured to perform the scrolling over time.

The controller may be configured to maintain a display position of the character at a predetermined position on the display screen.

The controller may be configured to display an animation of motion of the character at the predetermined position.

The controller may rotate the peripheral region around a position of the character in response to the rotation operation.

The portable game device may further include: a body portion including the controller. The rotation operation portion may be provided in a manner of protruding from the body portion in a first direction, and the controller may rotate, in response to the rotation operation in a first rotation direction as viewed from the first direction, the peripheral region in the first rotation direction, and rotate, in response to the rotation operation in a second rotation direction opposite to the first rotation direction, the peripheral region in the second rotation direction.

The controller may be configured to display the character facing in a direction opposite to the predetermined direction regardless of the rotation of the peripheral region.

An unenterable region may be set in a part of the virtual region, and the controller may not perform the scrolling in a case in which the unenterable region has a positional relationship of overlapping with the character during the scrolling.

The unenterable region may be displayed as a first game element having an image size larger than an image size of the unenterable region, and the controller may be configured to display the character and the peripheral region from an obliquely downward perspective, and the controller preferentially may display an image of one of the first game element and the character which is located at a lower portion of the display screen, when the character and the first game element have the overlapping positional relationship.

The controller may be configured to maintain an orientation of an image of the first game element regardless of the rotation of the peripheral region.

A second game element may be disposed in the virtual region, and under a condition that the scrolling has progressed while the second game element remains in a positional relationship of overlapping with the character during the scrolling, the controller may subsequently stop the scrolling for a first predetermined time.

The controller may continue, for a second predetermined time immediately after the scrolling has been stopped for the first predetermined time, the scrolling even in the case in which the scrolling has progressed while the second game element remains in the positional relationship of overlapping with the character during the scrolling.

The second game element may move in the virtual region.

The controller may evaluate the executed electronic game based on stop of the scrolling.

The controller may display, when the scrolling is stopped, an image presenting contact between the character and the second game element.

A target arrival position may be set in the virtual region, and the controller may end, when the electronic game progresses and the character and the target arrival position overlap with each other, the electronic game.

A background image of the virtual region may be a background image selected from a plurality of background image candidates, and the background image of the virtual region may be selected from the plurality of background image candidates depending on a state of the character at a start of the electronic game.

The controller may cause the display screen to display an image corresponding to a display of the target arrival position at the start of the electronic game.

The controller may evaluate the executed electronic game based on an elapsed time from a start of the electronic game until the character and the target arrival position overlap with each other.

An arrangement pattern of an object in the virtual region may be an arrangement pattern selected from a plurality of arrangement pattern candidates.

The arrangement pattern may be switched among the plurality of arrangement pattern candidates each time the electronic game is executed.

A non-transitory computer-readable storage medium stores a control program for causing a portable game device to perform a process. The portable game device executes an electronic game and includes a display screen, a rotation operation portion enabling a rotation operation, and a processor configured to control a progress of the electronic game, and the process includes: causing the display screen to display a character and a peripheral region of the character in a virtual region in which the character is present; presenting movement of the character by causing the peripheral region to scroll in a predetermined direction; and presenting a change in a movement direction of the character by rotating the peripheral region in response to the rotation operation on the rotation operation portion.

According to the present disclosure, it is possible to provide a highly interesting game experience.

1. A portable game device that executes an electronic game, the portable game device comprising:
a display screen;
a rotation operation portion enabling a rotation operation; and
a controller configured to control a progress of the electronic game, wherein
in the electronic game, the controller is configured to:
cause the display screen to display a character and a peripheral region of the character in a virtual region in which the character is present;
present movement of the character by causing the peripheral region to scroll in a predetermined direction; and
present a change in a movement direction of the character by rotating the peripheral region in response to the rotation operation on the rotation operation portion.

2. The portable game device according to claim 1, wherein
the controller is configured to perform the scrolling over time.

3. The portable game device according to claim 1, wherein
the controller is configured to maintain a display position of the character at a predetermined position on the display screen.

4. The portable game device according to claim 3, wherein
the controller is configured to display an animation of motion of the character at the predetermined position.

5. The portable game device according to claim 1, wherein
the controller rotates the peripheral region around a position of the character in response to the rotation operation.

6. The portable game device according to claim 1, further comprising:
a body portion including the controller, wherein
the rotation operation portion is provided in a manner of protruding from the body portion in a first direction, and
the controller rotates, in response to the rotation operation in a first rotation direction as viewed from the first direction, the peripheral region in the first rotation direction, and rotates, in response to the rotation operation in a second rotation direction opposite to the first rotation direction, the peripheral region in the second rotation direction.

7. The portable game device according to claim 1, wherein
the controller is configured to display the character facing in a direction opposite to the predetermined direction regardless of the rotation of the peripheral region.

8. The portable game device according to claim 1, wherein
an unenterable region is set in a part of the virtual region, and
the controller does not perform the scrolling in a case in which the unenterable region has a positional relationship of overlapping with the character during the scrolling.

9. The portable game device according to claim 8, wherein
the unenterable region is displayed as a first game element having an image size larger than an image size of the unenterable region, and
the controller is configured to display the character and the peripheral region from an obliquely downward perspective, and
the controller preferentially displays an image of one of the first game element and the character which is located at a lower portion of the display screen, when the character and the first game element have the overlapping positional relationship.

10. The portable game device according to claim 9, wherein
the controller is configured to maintain an orientation of an image of the first game element regardless of the rotation of the peripheral region.

11. The portable game device according to claim 1, wherein
a second game element is disposed in the virtual region, and
under a condition that the scrolling has progressed while the second game element remains in a positional relationship of overlapping with the character during the scrolling, the controller subsequently stops the scrolling for a first predetermined time.

12. The portable game device according to claim 11, wherein
the controller continues, for a second predetermined time immediately after the scrolling has been stopped for the first predetermined time, the scrolling even in the case in which the scrolling has progressed while the second game element remains in the positional relationship of overlapping with the character during the scrolling.

13. The portable game device according to claim 11, wherein
the second game element moves in the virtual region.

14. The portable game device according to claim 11, wherein
the controller evaluates the executed electronic game based on stop of the scrolling.

15. The portable game device according to claim 11, wherein
the controller displays, when the scrolling is stopped, an image presenting contact between the character and the second game element.

16. The portable game device according to claim 1, wherein
a target arrival position is set in the virtual region, and
the controller ends, when the electronic game progresses and the character and the target arrival position overlap with each other, the electronic game.

17. The portable game device according to claim 16, wherein
a background image of the virtual region is a background image selected from a plurality of background image candidates, and
the background image of the virtual region is selected from the plurality of background image candidates depending on a state of the character at a start of the electronic game.

18. The portable game device according to claim 17, wherein
the controller causes the display screen to display an image corresponding to a display of the target arrival position at the start of the electronic game.

19. The portable game device according to claim 16, wherein
the controller evaluates the executed electronic game based on an elapsed time from a start of the electronic game until the character and the target arrival position overlap with each other.

20. The portable game device according to claim 1, wherein
an arrangement pattern of an object in the virtual region is an arrangement pattern selected from a plurality of arrangement pattern candidates.

21. The portable game device according to claim 20, wherein
the arrangement pattern is switched among the plurality of arrangement pattern candidates each time the electronic game is executed.

22. A non-transitory computer-readable storage medium storing a control program for causing a portable game device to perform a process, wherein
the portable game device executes an electronic game and includes a display screen, a rotation operation portion enabling a rotation operation, and a processor configured to control a progress of the electronic game, and
the process comprises:
causing the display screen to display a character and a peripheral region of the character in a virtual region in which the character is present;
presenting movement of the character by causing the peripheral region to scroll in a predetermined direction; and
presenting a change in a movement direction of the character by rotating the peripheral region in response to the rotation operation on the rotation operation portion.
